(19) United States
(12) Patent Application Publication
(10) Pub. No.: US 2002/0076540 A1
(43) Pub. Date: Jun. 20, 2002

(54) Transfix component having mica-type silicate outer layer

(75) Inventors: Santokh S. Badesha, Pittsford, NY (US); Edward L. Schlueter JR., Rochester, NY (US)

Correspondence Address: John E. Beck, Xerox Corporation, Xerox Square 20A, Rochester, NY, 14644, US

(73) Assignee: Xerox Corporation

(21) Appl. No.: 09/737,413

(22) Filed: Dec. 14, 2000

(51) Int. Cl. B32B 7/02

(52) U.S. Cl. 428/212

(57) ABSTRACT

A transfix member with a substrate, an optional conformable intermediate layer, and thereover an outer coating with a mica-type layered silicate and silicone elastomer, where the silicone elastomer and the mica-type layered silicate form a delaminated nanocomposite, and a heating member associated with the substrate.

### CROSS REFERENCE TO RELATED APPLICATIONS

Reference is made to U.S. patent application Ser. No. 08/870,742, filed Jun. 6, 1997, entitled “Intermediate Toner Transfer Member,” Attorney Reference Number D/951461. The disclosure of this co-pending patent application is hereby incorporated by reference in its entirety.

### BACKGROUND OF THE INVENTION

The present invention relates generally to an imaging apparatus and layers for components thereof, and for use in electrostatographic, including digital, apparatuses. The layers herein are useful for many purposes including layers for transfix films or transfuse films, and the like. More specifically, the present invention relates to a transfix or transfuse member comprising a substrate, an optional intermediate layer, and an outer layer comprising a mica-type silicate material. The transfix member of the present invention may be used in xerographic machines, especially color machines.

In a typical electrostatographic reproducing apparatus such as electrophotographic imaging system using a photoreceptor, a light image of an original to be copied is recorded in the form of an electrostatic latent image upon a photosensitive member and the latent image is subsequently rendered visible by the application of a developer mixture. One type of developer used in such printing machines is a liquid developer comprising a liquid carrier having toner particles dispersed therein. Generally, the toner is made up of resin and a suitable colorant such as a dye or pigment. Conventional charge director compounds may also be present. The liquid developer material is brought into contact with the electrostatic latent image and the colored toner particles are deposited thereon in image configuration.

The developed toner image recorded on the imaging member can be transferred to an image receiving substrate such as paper via an intermediate transfer member. Alternatively, the developed image can be transferred to an intermediate transfer member from the image receiving member via another transfer member. The toner particles may be transferred by heat and/or pressure to an intermediate transfer member, or more commonly, the toner image particles may be electrostatically transferred to the intermediate transfer member by means of an electrical potential between the imaging member and the intermediate transfer member. After the toner has been transferred to the intermediate transfer member, it can then be transferred to the image receiving substrate, for example by contacting the substrate with the toner image on the intermediate transfer member under heat and/or pressure. Alternatively, the developed image can be transferred to another intermediate transfer member such as a transfix or transfer member. A transfix or transfuse member uses heat associated with the transfer member in order to both transfer and fix or fuse the developed image to a copy substrate.

Intermediate transfer members, including transfix or transfuse members, enable high throughput at modest process speeds. In four-color photocopier systems, the transfer member also improves registration of the final color toner image. In such systems, the four component colors of cyan, yellow, magenta and black may be synchronously developed onto one or more imaging members and transferred in registration onto a transfer member at a transfer station.

In electrostatographic printing machines in which the toner image is transferred from the transfix member to the image receiving or copy substrate, it is important that the transfer of the toner particles from the transfix member to the image receiving substrate be substantially 100 percent. Less than complete transfer to the image receiving substrate results in image degradation and low resolution. Completely efficient transfer is particularly important when the imaging process involves generating full color images since undesirable color deterioration in the final colors can occur when the color images are not completely transferred from the transfer member.

Thus, it is important that the transfix member surface has excellent release characteristics with respect to the toner particles. Conventional materials known in the art for use as transfix members often possess the strength, conformability and electrical conductivity necessary for use as transfix members, but can suffer from poor toner release characteristics, especially with respect to higher gloss image receiving substrates. When heat is associated with a transfer member, such as in the case of a transfix member, the transfix member must also possess good thermal conductivity in addition to superior release characteristics. Also, there is a need for mechanical strength for wear resistance. A transfix member undergoes multiple cycling during use.

In addition, in the event that electrically conductive fillers are needed to build electrical and thermal conductivities, and/or mechanical strength, it is necessary that the fillers be compatible with the materials used in the transfix member. Similarly, if release fluids are used, the materials in the transfix member and the fillers, if used, must be compatible with the release fluid materials. Also, the fillers, if used, and the materials in the transfix members must be chemically compatible with toners or liquid developers used in the electrostatographic apparatus.

U.S. Pat. No. 5,361,126 discloses an imaging apparatus including a transfer member including a heater and pressure-applying roller, wherein the transfer member includes a fabric substrate and an impurity-absorbent material as a top layer. The impurity-absorbing material can include a rubber elastomer material.

U.S. Pat. No. 5,337,129 discloses an intermediate transfer component comprising a substrate and a ceramer or grafted ceramer coating comprised of integral, interpenetrating networks of haloelastomer, silicon oxide, and optionally polyorganosiloxane.

U.S. Pat. No. 5,340,679 discloses an intermediate transfer component comprised of a substrate and thereover a coating comprised of a volume grafted elastomer, which is a substantially uniform integral interpenetrating network of a hybrid composition of a fluoroelastomer and a polyorganosiloxane.

U.S. Pat. No. 5,480,938 describes a low surface energy material comprising a volume grafted elastomer which is a substantially uniform integral interpenetrating network of a hybrid composition of a fluoroelastomer and a polyorganosiloxane, the volume graft having been formed by dehydrofluorination of fluoroelastomer by a nucleophilic dehydrofluorinating agent, followed by a hydrosilation reaction, addition of a hydrogen functionally terminated polyorganosiloxane and a hydrosilation reaction catalyst

U.S. Pat. No. 5,366,772 describes a fuser member comprising a supporting substrate, and a outer layer comprised of an integral interpenetrating hybrid polymeric network comprised of a haloelastomer, a coupling agent, a functional polyorganosiloxane and a crosslinking agent.

U.S. Pat. No. 5,456,987 discloses an intermediate transfer component comprising a substrate and a titamer or grafted titamer coating comprised of integral, interpenetrating networks of haloelastomer, titanium dioxide, and optionally polyorganosiloxane.

U.S. Pat. No. 5,848,327 discloses an electrode member positioned near the donor member used in hybrid scavengeless development, wherein the electrode members have a composite haloelastomer coating.

U.S. Pat. No. 5,576,818 discloses an intermediate toner transfer component including: (a) an electrically conductive substrate; (b) a conformable and electrically resistive layer comprised of a first polymeric material; and (c) a toner release layer comprised of a second polymeric material selected from the group consisting of a fluorosilicone and a substantially uniform integral interpenetrating network of a hybrid composition of a fluoroelastomer and a polyorganosiloxane, wherein the resistive layer is disposed between the substrate and the release layer.

U.S. Pat. No. 6,037,092 discloses a fuser member comprising a substrate and at least one layer thereover, the layer comprising a crosslinked product of a liquid composition which comprises (a) a fluorosilicone, (b) a crosslinking agent, and (c) a thermal stabilizing agent comprising a reaction product of (i) a cyclic unsaturated-alkyl-group-substituted polyorganosiloxane, (ii) a linear unsaturated-alkyl-group-substituted polyorganosiloxane, and (iii) a metal acetylacetonate or metal oxalate compound.

U.S. Pat. No. 5,537,194 discloses an intermediate toner transfer member comprising: (a) a substrate; and (b) an outer layer comprised of a haloelastomer having pendant hydrocarbon chains covalently bonded to the backbone of the haloelastomer.

U.S. Pat. No. 5,753,307 discloses fluoroelastomer surfaces and a method for providing a fluoroelastomer surface on a supporting substrate which includes dissolving a fluoroelastomer; adding a dehydrofluorinating agent; adding an amino silane to form a resulting homogeneous fluoroelastomer solution; and subsequently providing at least one layer of the homogeneous fluoroelastomer solution to the supporting substrate.

U.S. Pat. No. 5,840,796 describes polymer nanocomposites including a mica-type layered silicate and a fluoroelastomer, wherein the nanocomposite has a structure selected from the group consisting of an exfoliated structure and an intercalated structure.

U.S. Pat. No. 5,846,643 describes a fuser member for use in an electrostatographic printing machine, wherein the fuser member has at least one layer of an elastomer composition comprising a silicone elastomer and a mica-type layered silicate, the silicone elastomer and mica-type layered silicate form a delaminated nanocomposite with silicone elastomer inserted among the delaminated layers of the mica-type layered silicate.

The following three documents relate to nanocomposites, the disclosures of said three documents are hereby incorporated by reference in their entirety:

Shelly D. Burnside and Emmanuel P. Giannelis, “Synthesis and Properties of New Poly(Dimethylsiloxane) Nanocomposites,” CHEMISTRY OF MATERIALS, vol. 7, no. 9, pp. 1597-1600 (September 1995);

A set of fifteen slides (including the cover page) titled “Synthesis, Characterization, and Properties of Siloxane Nanocomposites,” presented by Shelly D. Burnside and Emmanuel P. Giannelis at the American Chemical Society Northeastern Regional Meeting in Rochester, N.Y. on Oct. 23, 1995; and

A set of eighteen slides (including the cover page) titled “Polymer Matrix Nanocomposites,” presented by Emmanuel P. Giannelis at the American Chemical Society Northeastern Regional Meeting in Rochester, N.Y. on Oct. 25, 1995.

Therefore, it is desired to provide a transfix member that possesses the qualities of conformability for copy quality and latitude, and also being tough for wear resistance. It is also desired to provide a transfix member that is electrically conductive to enable electrostatically assisted transfer. It is further desired to provide a transfix member that has low surface energy for release capability, and is chemically resistant to toner ingredients and release agents to enable efficient toner transfer. A further desired characteristic is for a transfix member to have a reduced susceptibility to swelling in the presence of release oils. An additional desired property for the transfix member having heat associated therewith, is for the transfix member to be thermally stable and conducting for conduction of heat for fusing or fixing.

### SUMMARY OF THE INVENTION

The present invention includes, in embodiments: an image forming apparatus for forming images on a recording medium comprising a) a charge-retentive surface to receive an electrostatic latent image thereon; b) a development component to apply a developer material to the charge-retentive surface to develop the electrostatic latent image to form a developed image on the charge-retentive surface; c) a transfer component for transferring the developed image from the charge-retentive surface to an intermediate transfer component; d) an intermediate transfer component for receiving the developed image from the transfer component and transferring the developed image to a transfix component; and e) a transfix component to transfer the developed image from the intermediate transfer component to a copy substrate and to fix the developed image to the copy substrate, the transfix component comprising i) a transfix substrate, and thereover ii) an outer transfix layer comprising a mica-type layered silicate and silicone elastomer, the silicone elastomer and the mica-type layered silicate together forming a delaminated nanocomposite, and iii) a heating member associated with the transfix substrate.

The present invention further provides, in embodiments: a transfix member comprising a) a transfix substrate, and thereover b) a conformable intermediate layer comprising a polymeric material, and having thereon c) an outer transfix layer comprising a mica-type layered silicate and silicone elastomer, the silicone elastomer and the mica-type layered silicate together forming a delaminated nanocomposite, and d) a heating member associated with the transfix substrate.

The present invention also provides, in embodiments: an image forming apparatus for forming images on a recording medium comprising a) a charge-retentive surface to receive an electrostatic latent image thereon; b) a development component to apply a developer material to the charge-retentive surface to develop the electrostatic latent image to form a developed image on the charge-retentive surface; c) a transfer component for transferring the developed image from the charge-retentive surface to an intermediate transfer component; d) an intermediate transfer component for receiving the developed image from the transfer component and transferring the developed image to a transfix component; and e) a transfix component to transfer the developed image from the intermediate transfer component to a copy substrate and to fix the developed image to the copy substrate, the transfix component comprising: i) a transfix substrate comprising a material selected from the group consisting of metal and fabric, and thereover ii) a conformable intermediate layer comprising a material selected from the group consisting of fabrics, fluoropolymers and silicone rubber materials, and having thereon iii) an outer transfix layer comprising a mica-type layered silicate and silicone elastomer, the silicone elastomer and the mica-type layered silicate together forming a delaminated nanocomposite, and iv) a heating member associated with the transfix substrate.

### BRIEF DESCRIPTION OF THE DRAWINGS

The above embodiments of the present invention will become apparent as the following description proceeds upon reference to the drawings, which include the following figures:

FIG. 1 is an illustration of a general electrostatographic apparatus using a transfix member.

FIG. 2 is an enlarged view of an embodiment of a transfix system.

FIG. 3 is an enlarged view of an embodiment of a transfix belt configuration involving a fabric substrate, a conformable intermediate layer, and thin outer layer.

FIG. 4 is an enlarged view of an embodiment of a transfix belt configuration involving a metal substrate, an adhesive layer, and thin outer layer.

FIG. 5 is a schematic view of the process for forming a mica-type layered silicate and silicone elastomer nanocomposite.

FIG. 6 is a graph of weight toluene versus volume fraction of nanocomposite.

### DETAILED DESCRIPTION OF THE INVENTION

The present invention is directed to transfix members having layers. The transfix members can be film components including films, sheets, belts and the like, useful in electrostatographic, including digital, apparatuses. In one embodiment of the present invention, a transfix member comprises a substrate, an optional intermediate layer, and an outer layer comprising a mica-type silicate material and silicone elastomer. In a preferred embodiment, the intermediate layer may be conformable.

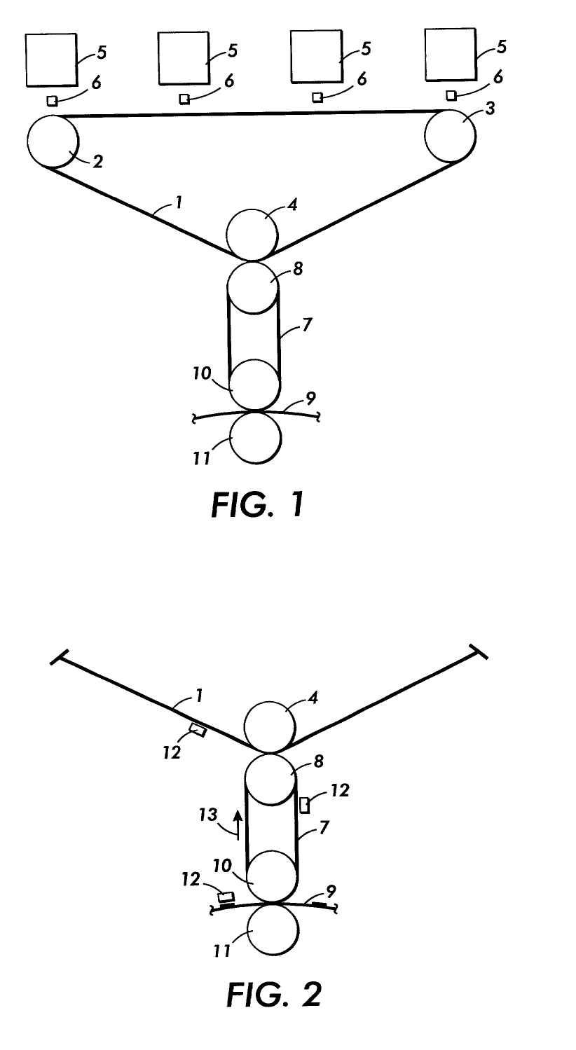

Referring to FIG. 1, there is depicted an image-forming apparatus comprising intermediate transfer member 1 advanced by rollers 2, 3 and 4. Intermediate transfer member 1 is depicted as a belt or film member, but may be of another useful form such as a belt, sheet, film, drum, roller or the like. An image is processed and developed by image processing units 5. There may be as few as 1 processing unit, for example, for 1 color processing such as black, and as many processing units as desired. In embodiments, each processing unit processes a specific color. In preferred embodiments, there are 4 processing units for processing cyan, black, yellow and magenta. The first processing unit processes one color and transfers this developed one-color image to the intermediate transfer member 1 via transfer member 6. The intermediate transfer member 1 is advanced to the next relevant processing unit 5 and the process is repeated until a fully developed image is present on the intermediate transfer member 1.

After the necessary number of images are developed by image processing members 5 and transferred to intermediate transfer member 1 via transfer members 6, the fully developed image is transferred to transfix member 7. The transfer of the developed image to transfix member 7 is assisted by rollers 4 and 8, either or both of which may be a pressure roller or a roller having heat associated therewith. In a preferred embodiment, one of 4 roller or 8 roller is a pressure member, wherein the other roller 4 or 8 is a heated roller. Heat may be applied internal or external to the roller. Heat may be supplied by any known heat source.

In a preferred embodiment, the fully developed image is subsequently transferred to a copy substrate 9 from transfix member 7. Copy substrate 9, such as paper, is passed between rollers 10 and 11, wherein the developed image is transferred and fused to the copy substrate by transfix member 7 via rollers 10 and 11. Rollers 10 and/or 11 may or may not contain heat associated therewith. In a preferred embodiment, one of rollers 10 and 11 contains heat associated therewith in order to transfer and fuser the developed image to the copy substrate. Any form of known heat source may be associated with roller 10 and/or 11.

FIG. 2 demonstrates an enlarged view of a preferred embodiment of a transfix member 7 which may be in the form of a belt, sheet, film, roller, or like form. The developed image 12 positioned on intermediate transfer member 1, is brought into contact with and transferred to transfix member 7 via rollers 4 and 8. As set forth above, roller 4 and/or roller 8 may or may not have heat associated therewith. Transfix member 7 proceeds in the direction of arrow 13. The developed image is transferred and fused to a copy substrate 9 as copy substrate 9 is advanced between rollers 10 and 11. Rollers 10 and/or 11 may or may not have heat associated therewith.

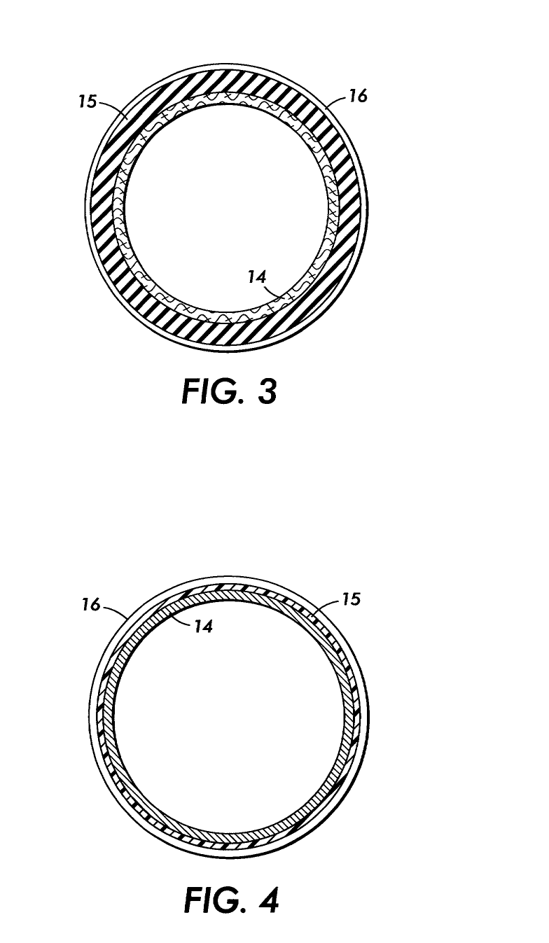

FIG. 3 demonstrates a preferred embodiment of the invention, wherein transfix member 7 comprises substrate 14, having thereover a conformable intermediate layer 15. Outer layer 16 is positioned on the intermediate layer 15. Substrate 14, in preferred embodiments, comprises metal or fabric. In a preferred embodiment, the substrate comprises a fabric material, the intermediate layer 15 is a conformable elastic layer, and the outer layer 16 is a thin overcoat. In another preferred embodiment as shown in FIG. 4, the intermediate layer 15 is an adhesive layer.

The transfix outer layer(s) herein comprise an outer release layer comprising a mica-type silicate material. In preferred embodiments, the outer release layer comprises a silicone elastomer and mica-type layered silicate material. In a preferred embodiment, the silicone elastomer and mica-type layered silicate form a delaminated nanocomposite. In a further preferred embodiment, the mica-type layered silicate has a high aspect ratio structure. In another preferred embodiment, the silicone elastomer is formed by curing a polyorganosiloxane. A preferred polyorganosiloxane has the following formula:

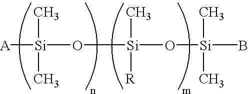

where R is hydrogen or substituted or unsubstituted alkyl, alkoxy, or alkenyl having from about 1 to about 20 carbon atoms, preferably from about 2 to about 10 carbon atoms, or aryl having from about 4 to about 12 carbon atoms, preferably from about 6 to about 10 carbon atoms; and where each of A and B may be any of alkyl or alkoxy having from about 1 to about 20 carbon atoms, preferably from about 2 to about 10 carbon atoms, hydroxy, or vinyl groups and 0<m/n<about 1, and m+n>about 350.

By way of example, A, B and R can be alkyl groups including alkoxy and substituted alkoxy. Specific examples include chloropropyl, trifluoropropyl, mercaptopropyl, carboxypropyl, aminopropyl, cyanopropyl and the like; and substituted alkoxy substituents such as glycidoxypropyl, methacryloxypropyl, and the like. Typical alkenyl substituents include vinyl, propenyl, and the like, while substituted alkenyl include halogen substituted materials such as chlorovinyl, bromopropenyl, and the like. Typical aryl or substituted aryl groups include phenyl, chlorophenyl, bromophenyl, and the like. Hydrogen, hydroxy, ethoxy and vinyl are preferred for A, B and/or R, because of superior crosslinkability. Methyl, trifluoropropyl and phenyl are generally preferred substituents for A, B and/or R in providing superior solvent and oil resistance, higher temperature stability and surface lubricity.

The ratio of m/n as preferably between 0 and 1 identifies the polyorganosiloxane as a copolymer. Similarly, the sum of m+n being greater than 350, identifies it as an elastomeric material.

Preferred polyorganosiloxanes are condensation curable polyorganosiloxanes, such as silanol-terminated polydimethylsiloxanes. Examples include those having the following formula:

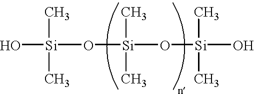

where n′ is an integer of from about 350 to about 2700, preferably from about from about 500 to about 1500.

The terminating silanol groups render the materials susceptible to condensation under acid or mild basic conditions. These groups are produced by kinetically controlled hydrolysis of chlorosilanes. Room temperature vulcanizable (RTV's) systems are formulated from these silanol terminated polymers with a molecular weight of from about 26,000 to about 200,000. These silanol-terminated polymers may be crosslinked with small quantities of multifunctional silanes which condense with the silanol group.

Suitable crosslinking agents for condensation cured polyorganosiloxanes include esters of orthosilicic acid, esters of polysilic acid, and alkyl trialkoxy silanes. Specific examples of suitable crosslinking agents for the condensation cured materials include tetramethylorthosilicate, tetraethylorthosilicate, 2-methyoxyethylsilicate, tetrahydrofurfurylsilicate, ethylpolysilicate, butylpolysilicate, and the like crosslinking agents. During the crosslinking reaction, an alcohol is typically split out leading to a crosslinked network. Condensed tetraethylorthosilicate is preferred as a crosslinking agent in the composition of the invention.

A sufficient amount of crosslinking agent is needed to completely crosslink the active end groups on the disilanol polymer. The amount of crosslinking agent required depends on the number average molecular weight of the disilanol polymer employed. With higher average molecular weight polymers, fewer active end groups are present and thus a lesser amount of crosslinking agent is required, and the opposite is true for lower average molecular weight polymers. Generally, with the preferred alpha omega hydroxy polydimethyl siloxane having a number average molecular weight of between about 26,000 to about 100,000 from about 6 to about 20 parts by weight of condensed tetraethylorthosilicate per 100 parts by weight of disilanol polymer is preferred.

In a particularly preferred embodiment of the present invention, a liquid addition-cured polyorganosiloxane is achieved by using siloxanes containing vinyl groups at the chain ends and/or scattered randomly along the chain along with siloxanes having two or more silicon hydrogen bonds per molecule. Typically these materials are cured at temperatures of from about 100° C. to about 250° C.

Typical addition-cured polyorganosiloxane materials are represented by the formula:

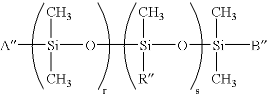

wherein s and r are integers and 0<s/r<1, about 350<r+s<about 2700. In the above formula, A″ and B″ can be hydroxy, alkoxy such as methoxy, ethoxy, propoxy, and the like, hydride, vinyl, amine and the like. R″ can be alkyl such as methyl, ethyl, propyl, butyl and the like, substituted alkyl such as chloropropyl, fluoropropyl, trifluoropropyl, and the like, phenyl, and vinyl.

For each molecule of the above formula, it is desired that there be at least a total of 2 vinyl groups in the A″, B″ and any of the several R″ sites within the formula. In the presence of suitable catalysts such as solutions or complexes of chloroplatinic acid or other platinum compounds in alcohols, ethers or divinylsiloxane, reaction occurs with temperatures of from about 100° C. to about 250° C. with the addition of polyfunctional silicon hydride to the unsaturated groups in the polysiloxane chain. Elastomers produced in this manner exhibit increased toughness, tensile strength and dimensional stability. Typically, these materials comprise the addition of two separate parts of the formulation, part A and part B, wherein part A contains the vinyl terminated polyorganosiloxane, the catalyst and the filler; and where part B contains the same or another vinyl terminated polyorganosiloxane, the crosslinked moiety such as a hydride functional silane and the same or additional filler. Part A and part B are normally in a ratio of one to one. Preferably, during the additional curing operation the material is crosslinked via the equation:

≡SiH+CH₂═CHSi≡→≡SiCH₂CH₂Si≡

Because hydrogen is added across the double bond, no offensive byproduct such as acids or alcohols is obtained.

Crosslinking catalysts are well-known in the art and include among others, stannous octoate, dibutyltindilaurate, dibutyltindiacetate, dibutyltindicaproate and the like, for the condensation cured polyorganosiloxanes.

A nanocomposite as used herein refers to nonoscale fillers in a polymer, an example being a mica-type layered silicate. A specific example is a mica-type layered silicate in an intercalated or exfoliated state in a polymer.

The term “delaminated” (also referred herein as exfoliated) refers to the host layers (having a thickness on a nanometer scale) being dispersed in a continuous polymer matrix.

The term “aspect ratio” shall refer to the ratio of the length to thickness of the mica-type layer silicates and the term high aspect ratio shall define a large dimensional ratio of the MTS.

Preferably, the mica-type layered silicate has a particle size having a maximum length of from about 1 to about 10 micrometers, and preferably from about 3 to about 5 micrometers.

The term “mica-type layered silicate” refers to a leaf or sheet-like laminated phyllosilicate mineral, typically natural or synthetic complex hydrous silicates based on aluminum, magnesium, sodium, potassium, calcium, lithium, iron and like silicates, having flat, six-sided monoclinic crystals, low hardness and perfect or near-perfect basal cleavage. Typically they have a high degree of flexibility, elasticity and toughness and have laminas of the order of about 10 angstroms in thickness, or from 1 to 20 angstroms, which under mild shear can be delaminated or exfoliated. Typical examples include the principle mica-types of the general formula:

W₂(X, Y)₄₋₆Z₈O₂₀(OH, F)₄

where W can be potassium or the like; X, Y are aluminum, magnesium, iron or lithium; and Z is silicon, aluminum, or both silicon and aluminum. In certain clay compositions some of the Z atoms can be silicon and the remaining Z atoms can be aluminum. Examples of mica-type silicates include muscovite, phlogopite, biotite, lepidolite, montmorillonite, bentonite, hectorite, vermiculite and saponite. The formula given above is by necessity only approximate since mica-type silicates (MTS) are minerals having various impurities. Commercially available materials include montmorillonite, bentonite and hectorite which are available from Southern Clay Products, Gonzales Tex. A list of suitable mica-type silicates can be found in the CRC Handbook of Chemistry and Physics 58th Edition, 1977-8, pp. B-250 to B-252 or in the 77th Edition, pp. 4-137 to 4-147, the disclosure of which is totally incorporated herein by reference. Two types of nanocomposites representing the end members of a structural hierarchy are possible: (a) intercalated, in which extended polymer chains are intercalated between the host layers resulting in a well ordered multilayer, where the layers of the silicate retain their structural registry; and (b) delaminated (also referred herein as exfoliated), in which the host layers having a thickness on a nanometer scale, are dispersed in a continuous polymer matrix. In contrast to the intercalated hybrids, the interlayer expansion in delaminated nanocomposites is comparable to the radius of gyration of the polymer, and the host layers have lost their structural registry.

The mica-type layered silicate may be present in the polydimethylsiloxane polymer in an amount ranging, for example, from about 1 to about 50, preferably from about 5 to about 20, and particularly preferred of from about 5 to about 10 percent by weight, based on the weight of the polymer.

As previously mentioned, the mica-type layered silicate has laminas on the order of about 10 angstroms in thickness. The layered silicate also has a large length to thickness ratio because of the plate-like structure which has a high aspect ratio. Typically the mica-type layered silicates have a maximum length on the order of 1 micrometer and an aspect ratio of length to thickness of from about 100 to about 1000. As a result, the mica-type layered silicates when used as a filler to enhance the thermal conductivity or modulus of the silicone elastomer, form a continuous touching path to conduct heat.

It is believed that the sheets of the mica-type layered silicate provide antioxidant properties due to their large surface area which thermally stabilizes the area that surrounds it. Further, the mica-type layered silicates provide a large surface area barrier to release agents, thereby resulting in reduction of swelling of the silicone elastomer.

The outer release layer may be prepared by mixing with mechanical shear a silicone elastomer, preferably a polyorganosiloxane, with a mica-type layered silicate to delaminate the layers of the mica-type layered silicate and to disperse the delaminated layers of the mica-type layered silicate in the silicone elastomer. A crosslinking agent and catalyst are added in amounts sufficient to provide crosslinking of the silicone elastomer. The silicone elastomer delaminated nanocomposite is shaped into a transfix member, and cured.

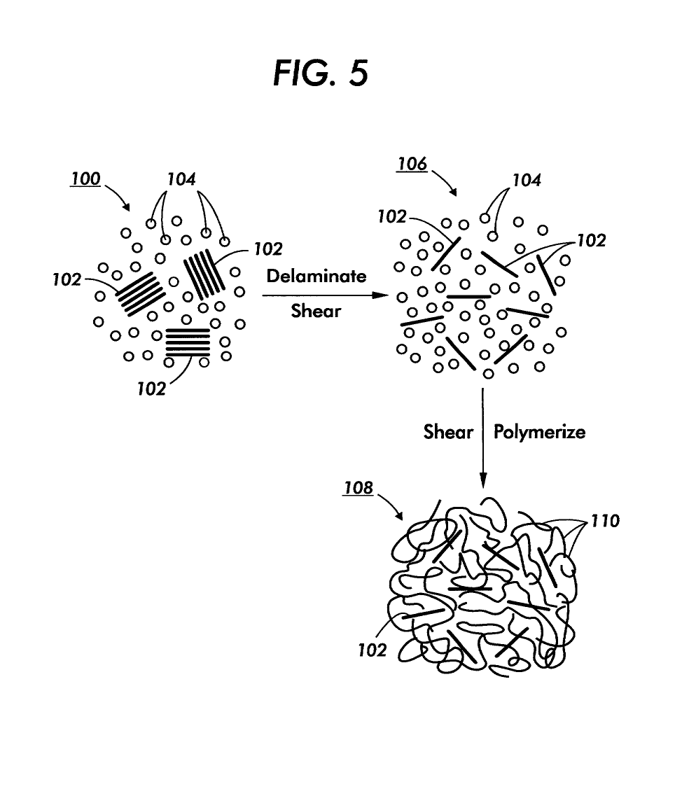

More specifically, attention is directed now to FIG. 5, wherein the manufacture of thermally stable swell resistant elastomer compositions is schematically illustrated. In this schematic, the first area 100 illustrates the laminated mica-type layered silicates 102 in a polyorganosiloxane monomer 104. When the mica-type layered silicates 102 are subjected to mechanical shear, the layers delaminate or exfoliate such that the polyorganosiloxane monomer 104 and individual layers of the mica-type layered silicate 102 are relatively uniformly mixed. This is illustrated in the second area 106 of the Figure. Upon the addition of suitable amounts of crosslinking agent and catalyst, and following the desired shaping, a delaminated nanocomposite is formed. Shaping can be accomplished by flow coating, slot coating, dipping or spraying onto a substrate surface such as a roll or by molding in the form of a roll and curing the shaped silicone elastomer composition to provide a silicone elastomer filled with a mica-type layered silicate. The silicone elastomer filled with mica-type layered silicate is illustrated in the third area 108 of the FIG. 3 with the delaminated layers of the mica-type layered silicate 102 dispersed among the silicone elastomer 110.

The delaminating phenomenon starts with surface treating the mica-type layered silicate with long chain alkyl ammonium salts or amino acids such as dimethyl dioctadecyl ammonium salt or n-dodecylamino acid. Surface treating provides the mica-type silicate with an organophilic nature. This will then enhance the wetting of the mica-type layered silicate by silicone materials. On mixing the surface treated mica-type layered silicate with silicone, the silicone penetrates the mica-type layered silicate lamellae causing each lamella to be surrounded by silicone as the mica-type silicate exfoliates.

Experiments to conduct swelling evaluations of the present silicone elastomer compositions have shown that the presence of only about 5 percent by weight in the elastomer composition of the mica-type layered silicates, when made into a silicone elastomer according to the present invention and subjected to swelling in the presence of polydimethylsiloxane oil, resulted in a reduction in swelling of about 50 percent. That is, the amount of swell was reduced by one-half with the presence of only about 5 percent by weight of the mica-type layered silicate.

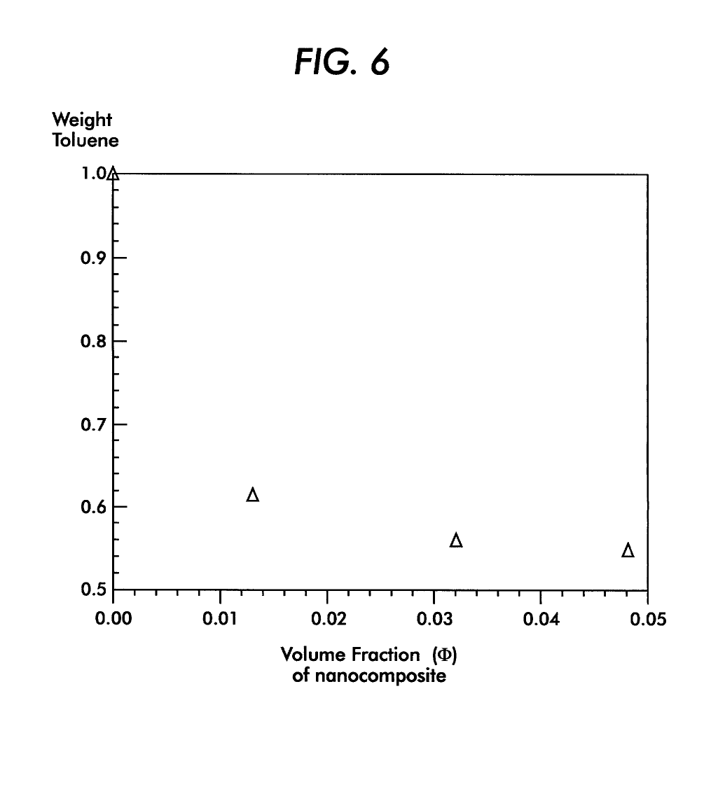

FIG. 6 is a graphical representation of the reduction in mass uptake as expressed as weight of toluene uptake in the illustrated volume fractions of the delaminated nanocomposite in toluene. FIG. 6 illustrates the swelling due to toluene in a silicone composition containing the stated volume fractions of the mica-type layered silicate. Since the ordinate axis represents the ratio of volume swell of silicone with mica-type layered silicate added to the volume swell of the silicone with no mica-type silicate added, there are no units and 1.0 represents the volume swell with no mica-type layered silicate added.

The transfix member may then be prepared by applying the elastomer having the mica-type layered silicate and any filler dispersed therein, directly to a substrate in one application or by successively applying layers of the elastomer composition to the substrate. The coating is most conveniently carried out by spraying or dipping in a light solution of homogeneous suspension containing the mica-type layered silicate. Molding, extruding and wrapping are also alternative techniques which may be used to make the transfix member.

Also, it is preferred that the outer transfix layer be relatively thin and have a thickness of from about 0.1 to about 10 mils, preferably from about 1 to about 5 mils.

The substrate can comprise any material having suitable strength and flexibility for use as a transfix member, enabling the member to cycle around rollers during use of the machine. Preferred materials for the substrate include metals, rubbers and fabrics. Preferred metals include steel, aluminum, nickel, and their alloys, and like metals and alloys of like metals. Examples of suitable rubbers include ethylene propylene dienes, silicone rubbers, fluoroelastomers, n-butyl rubbers and the like.

A fabric material, as used herein, refers to a textile structure comprised of mechanically interlocked fibers or filaments, which may be woven or nonwoven. Fabrics are materials made from fibers or threads and woven, knitted or pressed into a cloth or felt type structures. Woven, as used herein, refers to closely oriented by warp and filler strands at right angles to each other. Nonwoven, as used herein, refers to randomly integrated fibers or filaments. The fabric material should have high mechanical strength and possess electrical insulating properties.

Examples of suitable fabrics include woven or nonwoven cotton fabric, graphite fabric, fiberglass, woven or nonwoven polyimide (for example KELVAR® available from DuPont), woven or nonwoven polyamide, such as nylon or polyphenylene isophthalamide (for example, NOMEX® of E. I. DuPont of Wilmington, Del.), polyester, aramids, polycarbonate, polyacryl, polystyrene, polyethylene, polypropylene, cellulose, polysulfone, polyxylene, polyacetal, and the like, and mixtures thereof.

Preferably, the substrate is of a thickness of from about 2 to about 65 mils depending upon what substrate is chosen. In the case of metal substrate the thickness could vary to from about 2 to about 4 mils, preferably from about 2 mils. Alternatively, for fabric-backed substrate the thickness could vary from about 20 to about 65 mils, preferably from about 40 to about 60 mils.

There may be an optional intermediate layer positioned between the substrate and the outer release layer. Preferably, the conformable intermediate layer has a thickness of from about 5 to about 75 mils, preferably from about 25 to about 60 mils. Suitable materials for use in the conformable intermediate layer include fluoropolymers such as TEFLON®-type materials and fluoroelastomers such as copolymer, terpolymers and tetrapolymers having monomers such as, for example, vinylidene fluoride, hexafluoropropylene, tetrafluoropropylene and optional cure site monomers. Specific examples of fluoroelastomers include those commercially available and sold under the tradename VITON®, such as VITON® GF, VITON® GH, VITON® B50, and the like. Other suitable materials include silicone elastomers and fabrics such as those discussed above in connection with the substrate.

An adhesive layer may be positioned between the outer elastomer composition layer and the substrate. In the embodiment wherein a conformable intermediate layer is present, the adhesive layer may be positioned between the substrate and the conformable intermediate layer and/or between the conformable intermediate layer and the outer layer. The intermediate layer may have a thickness ranging, for example, from about 0.1 mil to about 3 mils, and more preferably from about 1 mil to about 2 mils. Examples of intermediate layers include adhesives such as: THIOXON 403/404™ and THIOXON 330/301™ both available from Morton International of Ohio; GE-2872-074™ available from the General Electric Company which is believed to be a copolymer of polyimide and siloxane; a silane coupling agent such as Union Carbide A-1100™ which is an amino functional siloxane; epoxy resins including bisphenol A epoxy resins available for example from Dow Chemical Company such as Dow TACTIX 740™, Dow TACTIX 741™, and Dow TACTIX 742™, and the like, optionally with a crosslinker or curative such as DOW H41™ available from the Dow Chemical Company.

Examples of suitable transfix members include a sheet, a film, a web, a foil, a strip, a coil, a cylinder, a drum, an endless strip, a circular disc, a belt including an endless belt, an endless seamed flexible belt, an endless seamless flexible belt, an endless belt having a puzzle cut seam, and the like. It is preferred that the substrate having the outer layer thereon, be an endless seamed flexible belt or seamed flexible belt, which may or may not include puzzle cut seams.

The transfix film, preferably in the form of a belt, has a width, for example, of from about 150 to about 2,000 mm, preferably from about 250 to about 1,400 mm, and particularly preferred is from about 300 to about 500 mm. The circumference of the belt is preferably from about 75 to about 2,500 mm, more preferably from about 125 to about 2,100 mm, and particularly preferred from about 155 to about 550 mm.

Specific embodiments of the invention will now be described in detail. These examples are intended to be illustrative, and the invention is not limited to the materials, conditions, or process parameters set forth in these embodiments. All parts are percentages by weight of total solids as defined above unless otherwise indicated.

### EXAMPLES

### Example 1

### Preparation of Mica-Type Layered Silicates and Silicone Elastomer Nanocomposite

Two samples of mica-type layered silicate and silicone elastomer were prepared as follows. To 100 parts of a 750 centipoise alpha, omega-dihydroxysilicone obtained from United Chemical Technologies, Inc. and designated as PS342.5, 2.5 parts of tetraethoxysilane crosslinker obtained from Aldrich Chemical Company and 2 parts of Tin(II) ethylhexanoate catalyst obtained from Chemat and designated as T722 were added. The three ingredients were well mixed using a micro-tip ultrasound probe available from Sonics & Materials. Another sample had 10 parts of montmorillonite (surface treated with an amine surfactant, dimethyl ditallow ammonium bromide) mixed into the 104.5 parts of dihydroxysilicone-crosslinker-catalyst material via the micro-tip ultrasound probe.

### Example 2

### Preparation of Mica-Type Layered Silicate and Silicone Elastomer Nanocomposite Outer Layer

To 100 parts of a 750 centipoise alpha, omega-dihydroxysilicone obtained from United Chemical Technologies, Inc. and designated as PS342.5, 2.5 parts of tetraethoxysilane crosslinker obtained from Aldrich Chemical Company and 2 parts of Tin(II) ethylhexanoate catalyst obtained from Chemat and designated as T722, were added. The three ingredients were well mixed using a micro-tip ultrasound probe available from Sonics & Materials and montmorillonite (surface treated with an amine surfactant, dimethyl ditallow ammonium bromide) was also added and mixed into the dihydroxysilicone-crosslinker-catalyst mixture using a micro-tip ultrasound probe. The specimens were made using samples ranging from 3 to 10 weight percent of surface treated montmorillonite (3 to 10 parts per hundred of the PS342.5).

### Example 3

### Preparation of Mica-Type Layered Silicate and Silicone Elastomer Nanocomposite on Metal Substrate

The nanocomposites prepared in accordance with Examples 1 and 2 may be used as a layer for a transfuse or transfix component used in electrostatographic printing machines. A component having the nanocomposite prepared in accordance with Examples 1 and 2 may be applied directly to a base member or substrate in one application or by successively applying layers of the nanocomposite to the base member. The coating of the nanocomposite compositions is most conveniently carried out by conventional coating methods, such as flow coating, slot spraying or dipping.

To 100 parts of a 750 centipoise alpha, omega-dihydroxysilicone obtained from United Chemical Technologies, Inc. and designated as PS342.5, 2.5 parts of tetraethoxysilane crosslinker obtained from Aldrich Chemical Company and 2 parts of Tin(II) ethylhexanoate catalyst obtained from Chemat and designated as T722 were added. The above three ingredients along with 10 parts of montmorillonite (surface treated with an amine surfactant, dimethyl ditallow ammonium bromide) were mixed as described in the Examples 1 and 2. This dispersion was then coated onto a 110 long and 11 inches wide stainless steel seamed belt. The thickness of the belt was 2 mil. After coating, the belt was and dried and cured at ambient temperature for 12 hours. The dry thickness of this coating was determined to be about 4.0 mils.

While the invention has been described in detail with reference to specific and preferred embodiments, it will be appreciated that various modifications and variations will be apparent to the artisan. All such modifications and embodiments as may readily occur to one skilled in the art are intended to be within the scope of the appended claims.

We claim:

1. An image forming apparatus for forming images on a recording medium comprising:
a) a charge-retentive surface to receive an electrostatic latent image thereon;
b) a development component to apply a developer material to said charge-retentive surface to develop said electrostatic latent image to form a developed image on said charge-retentive surface;
c) a transfer component for transferring said developed image from said charge-retentive surface to an intermediate transfer component;
d) an intermediate transfer component for receiving said developed image from said transfer component and transferring said developed image to a transfix component; and
e) a transfix component to transfer the developed image from said intermediate transfer component to a copy substrate and to fix said developed image to said copy substrate, said transfix component comprising:
i) a transfix substrate, and thereover
ii) an outer transfix layer comprising a mica-type layered silicate and silicone elastomer, said silicone elastomer and said mica-type layered silicate together forming a delaminated nanocomposite, and
iii) a heating member associated with said transfix substrate.

2. The image forming apparatus of claim 1, wherein said mica-type silicate has a general formula:
W₂(X, Y)₄₋₆Z₈O₂₀(OH, F)₄
where W is potassium; X is selected from the group consisting of aluminum, magnesium, iron and lithium, Y is selected from the group consisting of aluminum, magnesium, iron or lithium, and Z is selected from the group consisting of silicon, aluminum and mixtures thereof.

3. The image forming apparatus of claim 2, wherein said mica-type silicate is selected from the group consisting of muscovite, phlogopite, biotite, lepidolite, montmorillonite, bentonite, hectorite, vermiculite and saponite.

4. The image forming apparatus of claim 1, wherein said mica-type layered silicate is present in the outer transfix layer in an amount of from about 1 to about 50 weight percent based on the weight of the silicone elastomer.

5. The image forming apparatus of claim 4, wherein said mica-type layered silicate is present in the outer transfix layer in an amount of from about 5 to about 20 weight percent based on the weight of the silicone elastomer.

6. The image forming apparatus of claim 1, wherein said silicone elastomer is a polyorganosiloxane.

7. The image forming apparatus of claim 6, wherein said polyorganosiloxane has the following formula: 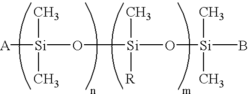
wherein R is selected from the group consisting of hydrogen, alkyl, alkoxy, alkenyl, and aryl; A is selected from the group consisting of alkyl, alkoxy, hydroxy and vinyl; B is selected from the group consisting of alkyl, alkoxy, hydroxy and vinyl; and 0<m/n<about 1 and m+n>about 350.

8. The image forming apparatus of claim 7, wherein A and B are vinyl.

9. The image forming apparatus of claim 6, wherein said polyorganosiloxane is a silanol-terminated polydimethylsiloxane having the following formula: 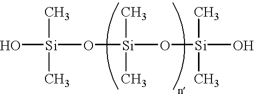
where n′ is an integer of from about 350 to about 2700.

10. The image forming apparatus of claim 6, wherein said polyorganosiloxane is an addition-cured polyorganosiloxane having the following formula: 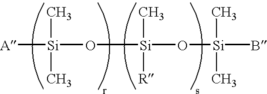
wherein s and r are integers and 0<s/r<1; A″ is selected from the group consisting of hydroxy, alkoxy, hydride, vinyl, and amine; B″ is selected from the group consisting of hydroxy, alkoxy, hydride, vinyl, and amine; and R″ is selected from the group consisting of alkyl, phenyl, and vinyl.

11. The image forming apparatus of claim 1, wherein said transfix substrate comprises a material selected from the group consisting of metal and fabric.

12. The image forming apparatus of claim 11, wherein said fabric material is selected from the group consisting of nonwoven cotton fabric, graphite fabric, fiberglass, woven polyimide, nonwoven polyimide, woven polyamide, nonwoven polyamide, polyester, aramids, polycarbonate, polyacryl, polystyrene, polyethylene, polypropylene, cellulose, polysulfone, polyxylene, polyacetal, and mixtures thereof.

13. The image forming apparatus of claim 1, wherein said transfix member further comprises a conformable intermediate layer positioned between said outer transfix layer and said transfix substrate.

14. The image forming apparatus of claim 13, wherein said conformable intermediate layer comprises a material selected from the group consisting of fabrics, fluoropolymers and silicone rubbers.

15. The image forming apparatus of claim 13, wherein said conformable intermediate layer has a thickness of from about 5 to about 75 mils.

16. The image forming apparatus of claim 1, wherein said outer transfix layer has a thickness of from about 0.1 to about 10 mils.

17. The image forming apparatus of claim 16, wherein said outer transfix layer has a thickness of from about 1 to about 5 mils.

18. The image forming apparatus of claim 13, wherein a first adhesive layer is positioned between said transfix substrate and said conformable intermediate layer.

19. The image forming apparatus of claim 1, wherein a second adhesive layer is positioned between said conformable intermediate layer and said outer transfix layer.

20. A transfix member comprising:
a) a transfix substrate, and thereover
b) a conformable intermediate layer comprising a polymeric material, and having thereon
c) an outer transfix layer comprising a mica-type layered silicate and silicone elastomer, said silicone elastomer and said mica-type layered silicate together forming a delaminated nanocomposite, and
d) a heating member associated with said transfix substrate.

21. An image forming apparatus for forming images on a recording medium comprising:
a) a charge-retentive surface to receive an electrostatic latent image thereon;
b) a development component to apply a developer material to said charge-retentive surface to develop said electrostatic latent image to form a developed image on said charge-retentive surface;
c) a transfer component for transferring said developed image from said charge-retentive surface to an intermediate transfer component;
d) an intermediate transfer component for receiving said developed image from said transfer component and transferring said developed image to a transfix component; and
e) a transfix component to transfer the developed image from said intermediate transfer component to a copy substrate and to fix said developed image to said copy substrate, said transfix component comprising:
i) a transfix substrate comprising a material selected from the group consisting of metal and fabric, and thereover
ii) a conformable intermediate layer comprising a material selected from the group consisting of fabrics, fluoropolymers and silicone rubber materials, and having thereon
iii) an outer transfix layer comprising a mica-type layered silicate and silicone elastomer, said silicone elastomer and said mica-type layered silicate together forming a delaminated nanocomposite, and
iv) a heating member associated with said transfix substrate.
